(19) United States
(12) Patent Application Publication
(10) Pub. No.: US 2002/0045513 A1
(43) Pub. Date: Apr. 18, 2002

(54) Method for operating a drivetrain of a motor vehicle and control system for implementing the method

(76) Inventors: Martin-Peter Bolz, Buehl (DE); Holger Huelser, Stuttgart (DE)

Correspondence Address: KENYON & KENYON, ONE BROADWAY, NEW YORK, NY, 10004, US

(21) Appl. No.: 09/896,210

(22) Filed: Jun. 29, 2001

(30) Foreign Application Priority Data
Jul. 6, 2000 (DE) 100 32 920.9

(51) Int. Cl. F16H 59/14; F16H 59/40

(52) U.S. Cl. 477/53

(57) ABSTRACT

A method for operating a drivetrain (1) of a motor vehicle, in which a multi-speed gearbox (10) is connected in series to an engine (2) via a torque converter (6), is intended to make it possible, in a particularly simple manner and with small expenditure, to consider the transmission ratio (u) of the multi-speed gearbox (10) in the engine management. To that end, according to the present invention, an actual value for the transmission ratio (u) of the multi-speed gearbox (10) is ascertained on the basis of a number of operating parameters characteristic for the operating state of the engine (2) and on the basis of one measured value characteristic for rotational speed (na) of driven shaft (12) of the multi-speed gearbox (10). In particular, speed ratio (v) of the torque converter (6), defined as the quotient of rotational speed (ng) of the output shaft of the torque converter (6) and the rotational speed of input shaft (nm) of the torque converter (6), is ascertained as an intermediate result from the engine speed (nm) and the engine torque (Tm).

The present invention relates to a method for operating a drivetrain of a motor vehicle, in which a multi-speed gearbox is connected in series to an engine via a torque converter. The invention also relates to a control system for a drivetrain of a motor vehicle for implementing the method.

A so-called multi-speed gearbox or variable-speed transmission can be used in the drivetrain of a motor vehicle. In contrast, for example, to a continuously variable transmission, CVT, such a multi-speed gearbox is only variable step-by-step in its gear ratio, i.e. in its transmission ratio defined by the quotient of the rotational speed of its input shaft and the rotational speed of its driven shaft. In this context, each step corresponds to one gear speed.

When used together with an electronically controlled engine, the exact knowledge of the transmission ratio of the multi-speed gearbox can be significant, for example, within the framework of a particularly comfortable engine management, to ensure a favorable dynamic performance in the event of surge damping. If, within the framework of the control of the drivetrain, an electronic control of the multi-speed gearbox is also provided, then, as a rule, measured values are available within the engine management both for the rotational speed of the input shaft of the multi-speed gearbox and for the rotational speed of the driven shaft of the multi-speed gearbox, so that the provision of a characteristic value for the transmission ratio of the multi-speed gearbox is unproblematic.

The provision of a characteristic value for the transmission ratio of the multi-speed gearbox is equally unproblematic in cases in which it may be that no electronic transmission-shift control is provided, but in which the rotational speed of the input shaft is correlated in a known manner with the engine speed. For example, this can be the case when the multi-speed gearbox is connected on the input side to the engine via a clutch. Namely, when the clutch is engaged, the ratio between the engine speed, which acts on the clutch on the input side, and the rotational speed of the input shaft of the multi-speed gearbox, the input shaft being permanently connected to the output shaft of the clutch, is equal to one or equal to another constant amount. Thus, the rotational speed of the input shaft of the multi-speed gearbox is determined in a clear manner by the engine speed - needed for the engine management and therefore known in the control system in any case - and is therefore available for the control. A measured value for the additionally needed rotational speed of the driven shaft of the multi-speed gearbox can then be provided via a suitable sensor.

However, it can also be desirable to consider the transmission ratio of a multi-speed gearbox in the case when no electronic control of the multi-speed gearbox is provided and it is also not connected to the engine via a clutch or in another fixed manner, but rather via a torque converter. In this case, no measured value characterizing the rotational speed of the input shaft of the multi-speed gearbox exists.

Therefore, the object of the present invention is to specify a method for operating a drivetrain of a motor vehicle of the type indicated above, which, in a particularly simple manner and with small expenditure, makes it possible to consider the transmission ratio of the multi-speed gearbox in the engine management. The intention is also to specify a control system particularly suitable for implementing the method.

With respect to the method, this objective is achieved according to the present invention by ascertaining an actual value for the transmission ratio of the multi-speed gearbox on the basis of a number of operating parameters characteristic for the operating state of the engine, and on the basis of one measured value characteristic for the rotational speed of the driven shaft of the multi-speed gearbox.

Advantageous refinements of the invention are the subject matter of the dependent claims.

The present invention is based on the consideration that, to take the transmission ratio of the multi-speed gearbox into account in the engine management, an instantaneous actual value should be available both for the rotational speed of the input shaft of the multi-speed gearbox and for the rotational speed of the driven shaft. A suitable rotational speed sensor can be provided for ascertaining the actual value of the driven-shaft rotational speed. Alternatively, a different measured value characteristic for the rotational speed of the driven shaft, such as a speed of a driven wheel or a measured value for the vehicular speed, can also be taken as a basis. Especially in this case, it is possible to fall back upon a sensor which is present anyway.

In this context, the rotational speed of the input shaft of the multi-speed gearbox could also be measured by a rotational speed sensor additionally provided especially for this purpose. However, this would be comparatively costly. Instead, it is rather provided to take advantage of the power-flow-wise coupling of the engine output shaft to the input shaft of the multi-speed gearbox via components whose characteristics are essentially known. This can be carried out by an evaluation of engine operating parameters available in any case.

The engine speed and the torque provided by the engine are advantageously utilized as operating parameters characteristic for the operating state of the engine. Namely, the electronic control of the engine is provided in any case with instantaneous information about the torque output by the engine. The output torque can be ascertained in known manner by calculation from the speed of the engine, taking into account its temperature and the quantity of air and/or fuel supplied.

For particularly simple further processing, the speed ratio of the torque converter is advantageously ascertained as an intermediate result from the engine speed and the torque provided by the engine. In this context, the speed ratio of the torque converter is defined as the quotient of the rotational speed of the output shaft of the torque converter and the rotational speed of the input shaft of the torque converter, it being possible for the input shaft of the torque converter to be permanently coupled to the output shaft of the engine, and for the output shaft of the torque converter to be permanently coupled to the input shaft of the multi-speed gearbox. The desired transmission ratio of the multi-speed gearbox can then be ascertained particularly easily from the speed ratio of the torque converter according to the equation

u=ν·nm/na

where u=the transmission ratio, ν=the speed ratio of the torque converter, nm=the engine speed, and na=the rotational speed of the driven shaft of the multi-speed gearbox.

The torque converter connected into the drivetrain can in particular be designed as a hydrodynamic converter. In this case, for particularly simple and therefore reliable further processing, the speed ratio of the torque converter is advantageously ascertained on the basis of the quotient of the torque provided by the engine and the square of the engine speed. Namely, for a hydrodynamic converter, the so-called pump torque or input torque applied to the input shaft is proportional to the square of the so-called pump speed or rotational speed of the input shaft. In this context, the proportionality constant is a function of the speed ratio of the converter. In the case of the converter downstream of the engine, its input shaft is permanently coupled to the output shaft of the engine, so that the pump torque can be treated as equivalent of the torque provided by the engine, and the pump speed can be treated as equivalent of the speed of the engine. Thus, variables which are present in any case are available for determining the proportionality constant. From this, it is then possible to determine the speed ratio of the hydrodynamic converter utilizing its known properties.

The speed ratio of the torque converter can be calculated from the proportionality constant, taking into account the so-called performance number of the converter, the density of the oil used in the converter, as well as the diameter of the converter. However, the speed ratio of the torque converter is advantageously ascertained with reference to a characteristic map stored for the engine speed and for the torque provided by the engine. Expediently stored in this characteristic map in the manner of a family of curves is the dependence of the pump torque (to be equated with the torque provided by the engine) on the pump speed (to be equated with the engine speed) for a plurality of speed ratios of the torque converter as a family parameter. The speed ratio of the torque converter is ascertained by determining to which of the stored curves the instantaneous value pair, composed of the torque provided by the engine and the engine speed, belongs. The characteristic map can have been ascertained, for example, with the aid of preceding calibration measurements.

Precisely because it can only be varied step-by-step, the multi-speed gearbox has only a limited number of possible transmission ratios. Therefore, for a correct identification of the transmission ratio, provision is advantageously made for a plausibility check of the ascertained transmission ratio in view of the possible transmission ratios. To that end, the transmission ratio ascertained for the multi-speed gearbox is expediently compared to a number of stored possible transmission ratios, that stored transmission ratio coming closest to the ascertained transmission ratio being regarded as the actually existing transmission ratio.

In a particularly favorable application, the transmission ratio of the multi-speed gearbox determined in one of the ways mentioned is taken into account in the event of a control intervention in the engine.

With respect to the control system, the objective indicated is achieved by an engine control unit that is connected on the input side to a diagnostic module which determines an actual value for the transmission ratio of the multi-speed gearbox based on a number of operating parameters characteristic for the operating state of the engine and based on one measured value characteristic for the rotational speed of the driven shaft of the multi-speed gearbox.

The diagnostic module is advantageously connected on the input side to a storage module in which a number of characteristic maps are stored for the engine speed and the torque provided by the engine. It is thus made possible, in a particularly time-saving as well as reliable manner, to ascertain the speed ratio of the torque converter as an intermediate result, based on which the transmission ratio can then be determined in a simple manner.

In further advantageous refinement, a number of possible transmission ratios of the multi-speed gearbox are stored in the storage module of the control system. This permits, in a particularly simple manner, a plausibility check of the ascertained transmission ratio and/or a subsequent improvement of the result value in view of theoretically possible result values.

The advantages attained by the present invention lie particularly in the fact that, by ascertaining the actual value for the transmission ratio of the multi-speed gearbox with the aid of a number of operating parameters characteristic for the operating state of the engine and on the basis of one measured value characteristic for the rotational speed of the driven shaft of the multi-speed gearbox, the transmission ratio can be taken into account in the engine management in a particularly simple manner. In so doing, no additional expenditure, e.g. in the form of the use of additional sensors, is necessary. In particular, the ascertainment of the transmission ratio on the basis of the speed ratio of the torque converter, which in turn is determined on the basis of the parameters of the engine speed and the torque provided by the engine that are available anyway, and with reference to the corresponding characteristic curves, allows a particularly reliable provision, achievable with simple means, of useful data for further processing in the control system.

An exemplary embodiment of the invention is explained more precisely with reference to a Drawing, in which:

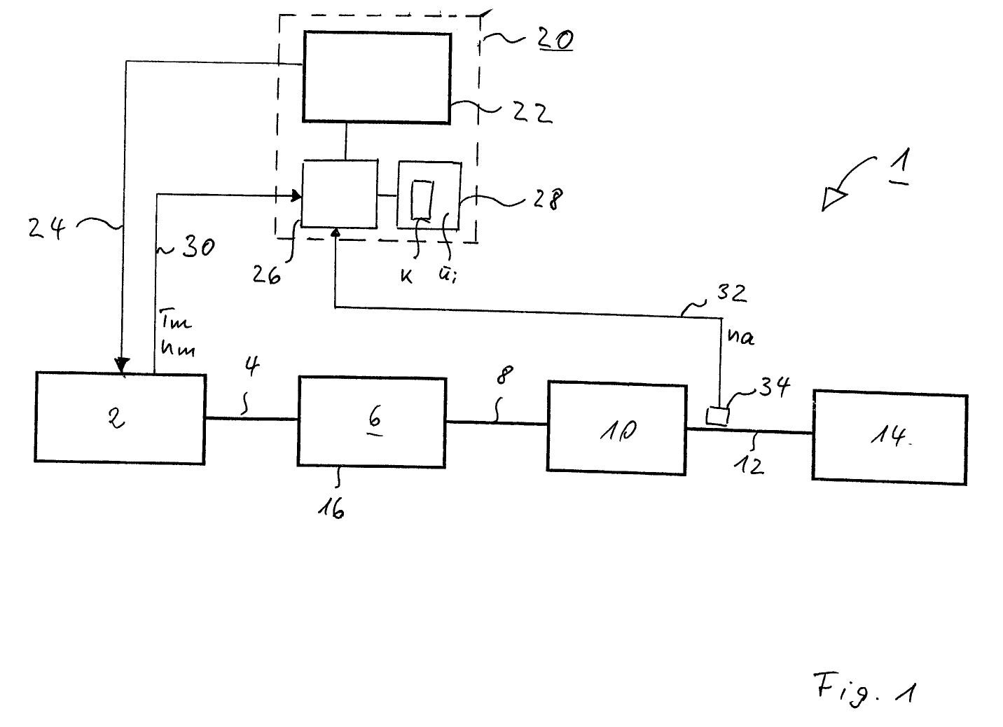

FIG. 1 shows schematically a drivetrain of a motor vehicle;

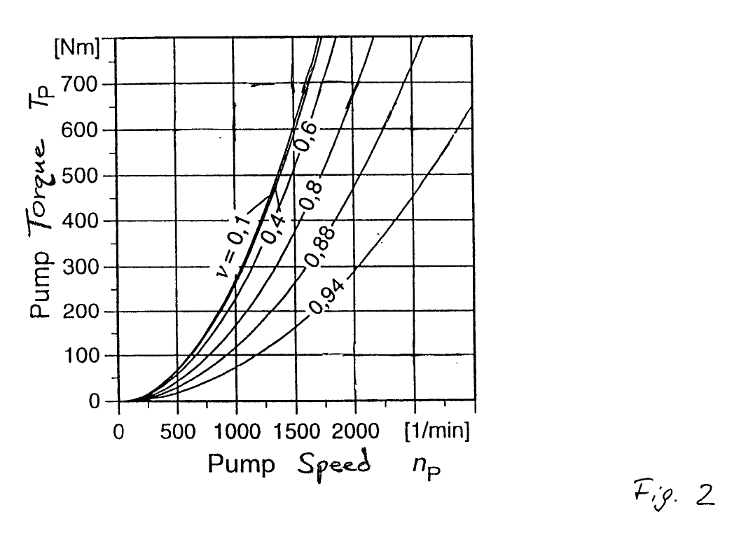

FIG. 2 shows a characteristic map of the dependence of a pump torque on the pump speed of a hydrodynamic converter.

Drivetrain 1 according to FIG. 1 has an engine 2 as vehicle engine which is connected via a shaft 4 to a torque converter 6. In this context, shaft 4 is provided equally as output shaft of engine 2 and as input shaft of torque converter 6. On the output side, torque converter 6 is connected via a shaft 8 to a variable-speed transmission or multiple-speed gearbox 10. Shaft 8 represents equally the output shaft of torque converter 6 and the input shaft of multi-speed gearbox 10. On the driven side or output side, multi-speed gearbox 10 is connected via its driven shaft 12 to a number of driven wheels 14. Thus, within drivetrain 1, multi-speed gearbox 10 is connected in series via torque converter 6 to engine 2.

In contrast to a continuously variable transmission, multi-speed gearbox 10 can only be varied step-by-step in its transmission. Transmission ratio u=ng/na, defined by the quotient of rotational speed ng of shaft 8 and rotational speed na of driven shaft 12, can only assume a value selectable from a number of values that are predetermined or predefined subject to design, each selectable value ui of transmission ratio u corresponding to one gear speed.

Torque converter 6 is designed as a hydrodynamic converter. In such a hydrodynamic converter, shaft 4, serving as input shaft, drives a blade wheel or impeller (not shown in greater detail) arranged at the end of the shaft within a fluid reservoir 16. Due to the rotational motion of the impeller caused thereby, the pressure in a working fluid, e.g. oil, held in fluid reservoir 16 is increased and is set into a circular flow. This in turn induces a rotational motion of a turbine, (not further shown) likewise arranged in fluid reservoir 16, the turbine being permanently connected to shaft 8 provided as output shaft of torque converter 6. In dependence on a load, e.g. a braking action, acting on shaft 8, and depending on further operating parameters of torque converter 6 such as the type and filling capacity of the working fluid, a rotational speed ng of shaft 8 and a torque Tg transmitted to shaft 8 ensue which can deviate from the rotational speed of shaft 4 or engine speed nm and from the moment of rotation or engine torque Tm provided by the engine and supplied via shaft 4.

An electronic control system 20 is allocated to drivetrain 1. Control system 20 includes an engine control unit 22 which, to output control commands, is connected via a signal line 24 to engine 2. On the incoming side, engine control unit 22 is connected to a diagnostic module 26 likewise belonging to control system 20. Diagnostic module 26 is in turn connected on the incoming side to a storage module 28 on one hand, and on the other hand, for the input of data relevant to operation, is connected via a data line 30 to engine 2, and via a data line 32 to a rotational speed sensor 34 arranged at driven shaft 12.

Control system 20 is designed for a particularly comfortable engine management. To that end, provision is made, inter-alia, in certain operating situations to take transmission ratio u of multi-speed gearbox 10 into account in the stipulation of manipulated variables for engine 2, for example, in the case of a measure for surge damping. To make it possible to consider transmission ratio u even without a separate rotational speed sensor at shaft 8, control system 20 is designed for ascertaining an actual value for transmission ratio u in light of operating parameters characteristic for the operating state of engine 2, and in light of one measured value characteristic for rotational speed na of driven shaft 12.

For that purpose, on one hand, rotational speed na of driven shaft 12, ascertained in rotational speed sensor 34, is input via data line 32 into diagnostic module 26. Instead, provision can also be made for a different parameter or measured value correlated in a clear manner to rotational speed na of the driven shaft, such as the vehicular speed or the speed of driven wheels 14, to be transmitted to diagnostic module 26.

In addition to rotational speed na of driven shaft 12, the determination of rotational speed ng of shaft 8 is also necessary for ascertaining the actual value for transmission ratio u. Control system 20 is not designed for an electronic control of multi-speed gearbox 10, so that rotational speed ng of shaft 8 is not readily available. A separate rotational speed sensor for measuring this rotational speed ng is likewise not provided. Therefore, diagnostic module 26 is designed such that initially speed ratio ν of torque converter 6 is ascertained as an intermediate result from the operating parameters of engine 2. This is defined as the quotient of rotational speed ng of shaft 8 and engine speed nm of shaft 4. Engine speed nm is an important parameter in any case for the engine management, and is therefore transmitted continuously to diagnostic module 26 via data line 30 anyway.

Thus, with knowledge of speed ratio ν of torque converter 6, the transmission ratio of multi-speed gearbox 10 can be ascertained according to the equation

u=νnm/na

Engine speed nm and engine torque Tm are provided as operating parameters of engine 2 to be taken into account for the ascertainment of speed ratio ν of torque converter 6 by diagnostic module 26. Namely, in the same way as engine speed nm, engine torque Tm is an operating parameter needed in any case within the framework of the engine management. A measured value characteristic for engine torque Tm can be transmitted via data line 30 to diagnostic module 26. Alternatively, however, engine torque Tm can also be calculated within diagnostic module 26 from other operating parameters, for example, from engine speed nm, taking into account the engine temperature and the quantity of air and/or fuel supplied.

The ascertainment of speed ratio v of torque converter 6 by diagnostic module 26 in light of engine speed nm and engine torque Tm is based on the knowledge that, when working with a hydrodynamic converter, the pump torque is proportional to the square of the pump speed. The proportionality factor or the proportionality constant is a function of speed ratio v. In the exemplary embodiment, engine 2 is permanently connected via shaft 4 to the input side of torque converter 6. Thus, in this case, the pump torque can be treated as equivalent of engine torque Tm, and the pump speed can be treated as equivalent of engine speed nm. Therefore, the following equation is applicable:

Tm=k(ν) nm²

Thus, when engine speed nm and engine torque Tm are known, by forming the quotient of engine torque Tm and of the square of engine speed nm, it is possible to determine k(ν), from which in turn speed ratio ν can be derived. In so doing, speed ratio ν can be calculated taking into account the so-called performance number of torque converter 6, the density of the working fluid used, as well as the diameter of the converter. However, in the exemplary embodiment, it is provided that speed ratio ν is ascertained with reference to a characteristic map K stored in storage module 28. As shown in FIG. 2, the dependence of the pump torque on the pump speed for a plurality of speed ratios ν is stored in this characteristic map in the manner of a family of curves, speed ratio ν being used as a family parameter.

Speed ratio ν is ascertained in diagnostic module 26 by first of all determining to which of the stored curves the respective acquired value pair, composed of engine speed nm and engine torque Tm, corresponds. Speed ratio ν allocated as family parameter to the identified curve is thereupon read in.

This ascertained speed ratio ν is utilized to calculate transmission ratio u. Transmission ratio u thus calculated is subsequently also subjected to a final check. In so doing, it is taken into consideration that, subject to design, the transmission ratio of multi-speed gearbox 10 can only assume one value from a number of possible values ui. These possible values ui are likewise stored in storage module 28. For the final check, a comparison is made as to whether calculated transmission ratio u agrees with one of possible values ui within a pre-definable tolerance range. If this is the case, then ascertained transmission ratio u is taken into consideration in the engine management in case of need. If, however, no concordance can be established, then either transmission ratio u can be determined again, or that value of possible values ui which comes the closest to ascertained transmission ratio u can be regarded as transmission ratio u actually existing.

The method indicated makes it possible in a comparatively simple manner, and particularly without the use of additional components, to take transmission ratio u into account in the engine management even in cases in which neither an electronic transmission-shift control nor a fixed speed ratio between the driven shaft of engine 2 and the input shaft of multi-speed gearbox 10 is given.

Reference numeral list

1 Drivetrain

2 Engine

4 Shaft

6 Torque converter

8 Shaft

10 Multi-speed gearbox

12 Driven shaft

14 Driven wheels

16 Liquid reservoir

20 Control system

22 Engine control unit

24 Signal line

26 Diagnostic module

28 Storage module

32,30 Data line

34 Rotational speed sensor

u Transmission ratio

ui Predefined values

na Rotational speed of shaft 8

nm Rotational speed of driven shaft 12

nm Engine speed

Tg Torque at shaft 8

Tm Engine torque

ν Speed ratio of torque converter 6

What is claimed is:

1. A method for operating a drivetrain (1) of a motor vehicle, in which a multi-speed gearbox (10) is connected in series to an engine (2) via a torque converter (6), an actual value for transmission ratio (u) of the multi-speed gearbox (10) being ascertained on the basis of a number of operating parameters characteristic for the operating state of the engine (2), and on the basis of one measured value characteristic for rotational speed (na) of driven shaft (12) of the multi-speed gearbox (10).

2. The method as recited in claim 1, in which engine speed (nm) and engine torque (Tm) are used as operating parameters characteristic for the operating state of the engine (2).

3. The method as recited in claim 2, in which speed ratio (ν) of the torque converter (6), defined as the quotient of rotational speed (ng) of the output shaft of the torque converter (6) and rotational speed of input shaft (nm) of the torque converter (6), is ascertained as an intermediate result from the engine speed (nm) and the engine torque (Tm).

4. The method as recited in claim 3, in which the speed ratio (ν) of the torque converter (6) is ascertained based on the quotient of the engine torque (Tm) and of the square of the engine speed (nm).

5. The method as recited in claim 3, in which the speed ratio (ν) of the torque converter (6) is ascertained on the basis of a characteristic map (K) stored for the engine speed (nm) and the engine torque (Tm).

6. The method as recited in one of claims 1 through 5, in which the transmission ratio (u) ascertained for the multi-speed gearbox (10) is compared to a number of stored possible transmission ratios, that stored transmission ratio which comes closest to the ascertained transmission ratio (u) being regarded as the actually existing transmission ratio (u).

7. The method as recited in one of claims 1 through 6, in which the transmission ratio (u) of the multi-speed gearbox (10) is taken into consideration in a control intervention in the engine (2).

8. A control system (20) for a drivetrain (1) of a motor vehicle, in which a multi-speed gearbox (10) is connected in series to an engine (2) via a torque converter (6), and in which an engine control unit (22) is connected on the input side to a diagnostic module (26) which ascertains an actual value for the transmission ratio (u) of the multi-speed gearbox (10) on the basis of a number of operating parameters characteristic for the operating state of the engine (2), and on the basis of one measured value characteristic for the rotational speed (na) of the driven shaft (12) of the multi-speed gearbox (10).

9. The control system (20) as recited in claim 8, whose diagnostic module (26) is connected on the input side to a storage module (28) in which are stored a number of characteristic maps (K) for the engine speed (nm) and the engine torque (Tm).

10. The control system (20) as recited in claim 8 or 9, in whose storage module (28) are stored a number of possible values (ui) for the transmission ratio (u) of the multi-speed gearbox (10).
